(19) United States
(12) Patent Application Publication
(10) Pub. No.: US 2024/0211890 A1
(43) Pub. Date: Jun. 27, 2024

(54) SYSTEM AND METHOD FOR AUTOMATIC RESUME IDENTIFICATION

(71) Applicants: Karthik Sridhar, Pune (IN); Bharadwaj Krishnan, Pune (IN)

(72) Inventors: Karthik Sridhar, Pune (IN); Bharadwaj Krishnan, Pune (IN)

(21) Appl. No.: 18/553,549

(22) PCT Filed: Mar. 22, 2022
(86) PCT No.: PCT/IB2022/052579

§ 371 Date: Sep. 30, 2023

(30) Foreign Application Priority Data
Mar. 30, 2021 (IN) 202121014390
Mar. 22, 2022 (WO) PCT/IB2022/052579

(51) Int. Cl. G06Q 10/107; G06Q 10/1053

(52) U.S. Cl. CPC G06Q 10/107; G06Q 10/1053

(57) ABSTRACT

A computing system 20 and method 30 for automatic resume identification is disclosed. It comprises a memory 205 coupled to hardware processors 245. The memory 205 comprises a plurality of modules in the form of programmable instructions executable by the hardware processors 245. A document retrieval module 210 automatically retrieves one or more documents from user devices, from one or more email servers 100b and from one or more cloud databases 100c. A document analyser module 215 analyses each of the documents retrieved based on a set of analyser rules. A validation module 220 validates each of the documents by determining a score of resume-ness and a score of non-resume-ness of each of the documents based on one or more predefined rules. A resume detection and extraction module 225 detects resumes based on the score of resume-ness and based on the score of non-resume-ness for each of the documents. An output module 230 displays the resumes detected on user interfaces of the user devices.

### CROSS-REFERENCE TO RELATED APPLICATIONS

This application claims priority from a patent application filed in India having Patent Application No. 202121014390 filed on Mar. 30, 2021, and also claims priority from a PCT Application having Patent Application No. PCT/IB2022/052579 filed on Mar. 22, 2022

### FIELD OF INVENTION

Embodiments of a present disclosure relate to computing systems and more particularly relates to a computing system and a method for automatic resume identification in a cloud computing environment.

### BACKGROUND

Generally, any recruitment process mainly includes three essential phases: (1) identifying the jobs vacancy and analyzing the job requirements. (2) receiving resumes and (3) weeding out unqualified applicants. Recruiters need to analyze many resumes with them, in a recruitment process. These resumes are stored in multiple folders of computer devices or in inbox of multiple email servers as email attachments or in multiple cloud databases, such as google drive, drop box and a like. The resumes may be typical documents in text format like doc, docx, pdf, and the like. Also, the resumes may be in an image format including textual content.

The computer devices, email servers as well as cloud databases of the recruiter not only contains resumes, but there are many other types of documents, such as agreements, confidential documents, legal notices, letters, articles and the like. The recruiter faces a problem of identifying resumes from the bulk of different varieties of documents stored on their computer devices, email servers and cloud databases.

In existing arts, the process of segregating and identifying resumes from the bulk of documents is done manually. Since storage of computer devices and email inboxes are inherently unorganized, it is a hectic task for recruiters to identify, access and navigate through the bulk stored resumes. Further, there remains chances of error and exclusion in the process.

Further, there has been efforts for building systems and methods for automatically identifying document types/resumes from the big bulk of documents stored. In one of the existing prior art system, a system and method for dividing content of an electronic document into components is disclosed. A document type of the electronic document is identified by comparing a document score against a document type criterion, the document score being based on a combination of a component score of each of the components. A user interface provides an indication of the document type.

Further, in another existing prior art system, a method for automatically processing electronic documents is disclosed. In one aspect, features and/or properties of words are identified from a set of training documents to aid in extracting information from documents to be processed. The features and/or properties relate to text of the words, position of the words and the relationship to other words. A classifier is developed to express these features and/or properties. During information extraction, documents are processed and analysed based on the classifier and information is extracted based on correspondence of the documents and the features/properties expressed by the classifier.

However, in both of the above mentioned existing prior art systems, accuracy in identifying resumes are low. Though they provide a time saving strategy, problem of error and exclusion in the process of identifying resumes still remains. Problem of identification of false document as resume and exclusion of genuine resume from being identified, still persists, and remains as an irritant in the work of recruiters.

Hence, there exists need of a technique for identifying and organizing the resumes from a big bulk of documents with high accuracy in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with a first embodiment of the present disclosure, a computing system is disclosed for automatic resume identification in a cloud computing environment. The system comprises one or more hardware processors and a memory coupled to the one or more hardware processors. The memory comprises a plurality of modules in the form of programmable instructions executable by the one or more hardware processors. The plurality of modules comprises a document retrieval module, a document analyser module, a validation module, a resume detection and extraction module, and an output module.

In accordance with the first embodiment, the document retrieval module configured to automatically retrieve one or more documents from one or more user devices, from one or more email servers and from one or more cloud databases. The document analyser module is configured to analyse each of the one or more documents retrieved. Each of the one or more documents is analysed based on a set of analyser rules. The validation module is configured to validate each of the analysed one or more documents by determining a score of resume-ness and a score of non-resume-ness of each of the one or more documents. The score of resume-ness and the score of non-resume-ness of each of the one or more documents are determined based on one or more predefined rules. The resume detection and extraction module is configured to detect one or more resumes based on the score of resume-ness and based on the score of non-resume-ness for each of the one or more documents. The output module configured to output the one or more resumes detected on one or more user interfaces of the one or more user devices.

In accordance with a second embodiment of the present disclosure, a computer implemented method for automatic resume identification in a cloud computing environment is disclosed. The method comprises the first step of retrieving automatically, by a document retrieval module executable by the one or more hardware processors, one or more documents from one or more user devices, from one or more email servers and from one or more cloud databases. The method comprises the second step of analysing, by a document analyser module, each of the one or more documents retrieved. Each of the one or more documents is analysed based on a set of analyser rules. The method comprises the third step of validating, by a validation module executable by the one or more hardware processors, each of the one or more documents by determining a score of resume-ness and a score of non-resume-ness of each of the one or more documents based on one or more predefined rules. The method comprises the fourth step of detecting, by a resume detection and extraction module executable by the one or more hardware processors, one or more resumes based on the score of resume-ness and based on the score of non-resume-ness for each of the one or more documents. The method comprises the final step of outputting, by an output module executable by the one or more hardware processors, the one or more resumes detected on one or more user interface of the one or more user devices.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary cloud computing environment for automatic resume identification, in accordance with an embodiment of the present disclosure;

FIG. 2 is a block diagram illustrating an exemplary computing system, such as those shown in FIG. 1, capable of automatically identifying resumes, in accordance with an embodiment of the present disclosure;

FIG. 3 is a process flow diagram illustrating an exemplary method for automatic resume identification, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” that is configured and operated to perform certain operations. In one embodiment, the “module” may be implemented mechanically or electronically, so a module may comprise dedicated circuitry or logic that is permanently configured (within a special-purpose processor) to perform certain operations. In another embodiment, a “module” may also comprise programmable logic or circuitry (as encompassed within a general-purpose processor or other programmable processor) that is temporarily configured by software to perform certain operations.

Accordingly, the term “module” should be understood to encompass a tangible entity, be that an entity that is physically constructed permanently configured (hardwired) or temporarily configured (programmed) to operate in a certain manner and/or to perform certain operations described herein.

Embodiments of the present disclosure disclose a computing system for automatic resume identification in a cloud computing environment. The system comprises one or more hardware processors and a memory coupled to the one or more hardware processors. The memory comprises a plurality of modules in the form of programmable instructions executable by the one or more hardware processors. The plurality of modules comprises a document retrieval module, a document analyser module, a validation module, a resume detection and extraction module, and an output module. In accordance with the first embodiment, the document retrieval module configured to automatically retrieve one or more documents from one or more user devices, from one or more email servers and from one or more cloud databases. The document analyser module is configured to analyse each of the one or more documents retrieved. Each of the one or more documents is analysed based on a set of analyser rules. The validation module is configured to validate each of the analysed one or more documents by determining a score of resume-ness and a score of non-resume-ness of each of the one or more documents. The score of resume-ness and the score of non-resume-ness of each of the one or more documents are determined based on one or more predefined rules. The resume detection and extraction module is configured to detect one or more resumes based on the score of resume-ness and based on the score of non-resume-ness for each of the one or more documents. The output module configured to output the one or more resumes detected on one or more user interfaces of the one or more user devices.

In the exemplary embodiment of present invention, the document analyser module comprises an extraction submodule, a recognition submodule, and a content reader submodule. The extraction submodule extracts one or more document properties based on the set of analyser rules. The one or more document properties comprise date of document creation, date of document modification, and author of document. The recognition submodule recognizes document type, sender and recipient of the document based on the set of analyser rules. The content reader submodule reads information contained in the document based on the set of analyser rules. The content reader submodule comprises an OCR component configured to read the one or more documents, using an image reader technique. The document analyzer further comprises a converter submodule configured to convert the one or more document in a standard compatible format for reading if the recognition submodule recognizes the document type of the one or more document in an incompatible format. The standard compatible format may be, but not limited to, .doc, .docx, pdf etc.

In the exemplary embodiment of present invention, the validation module comprises an identifier submodule, a resume-ness submodule, and a non-resume-ness submodule. The identifier submodule identifies one or more resume attributes, and one or more non-resume attributes in each of the one or more documents through a pattern recognition technique.

The resume-ness submodule determines the score of resume-ness of each of the one or more documents based on the one or more resume attributes identified. The non-resume-ness submodule determines the score of non-resume-ness of each of the one or more documents based on the one or more non-resume attributes identified.

In the exemplary embodiment of present invention, the one or more predefined rules to determine the score of resume-ness comprises detecting one or more predefined resume attributes in the document. The one or more predefined resume attribute comprises one or more resume sections, one or more typical resume phrases, one or more experience details, one or more education details, one or more email id type, and syntax of filename of the document. The example of resume sections may include work experience, education, and the like. The example of typical resume phrase may include achieved, improved, managed, resolved, and the like. The experience details may include job title, years of experience, and the like. The education details may include degree, passing year, and the like. The email id type may be a personal email ids, business email ids, job board email ids, and the like. The syntax of filename of the document may include candidate's name, resume specific keywords, such as—job title, word resume, and the like.

A resume-ness value is assigned for detection of each of the one or more predefined resume attributes and further, the resume-ness values are accumulated to determine the score of resume-ness for a document.

In the exemplary embodiment of present invention, the one or more predefined rules to determine the score of non-resume-ness comprises detecting one or more predefined non-resume attributes in the document. The one or more predefined non-resume attribute comprises one or more non-resume type format, one or more typical non-resume phrase, and one or more non-resume details. A non-resume-ness value is assigned for detection of each of the one or more predefined non-resume attributes, and further, the non-resume-ness values are accumulated to determine the score of non-resume-ness for a document.

In the exemplary embodiment of present invention, if the score of resume-ness is within a predefined resume-ness threshold, the resume detection and extraction module detects the document is a resume. Further, if the score of non-resume-ness is within a predefined non-resume-ness threshold, the resume detection and extraction module detects the document is not a resume. Furthermore, if the score of resume-ness is beyond a predefined resume-ness threshold and/or if the score of non-resume-ness is beyond a predefined non-resume-ness threshold, the resume detection and extraction module detects one or more resume documents based on a heuristic process. Furthermore, the resume detection and extraction module extracts resumes from a pool of documents.

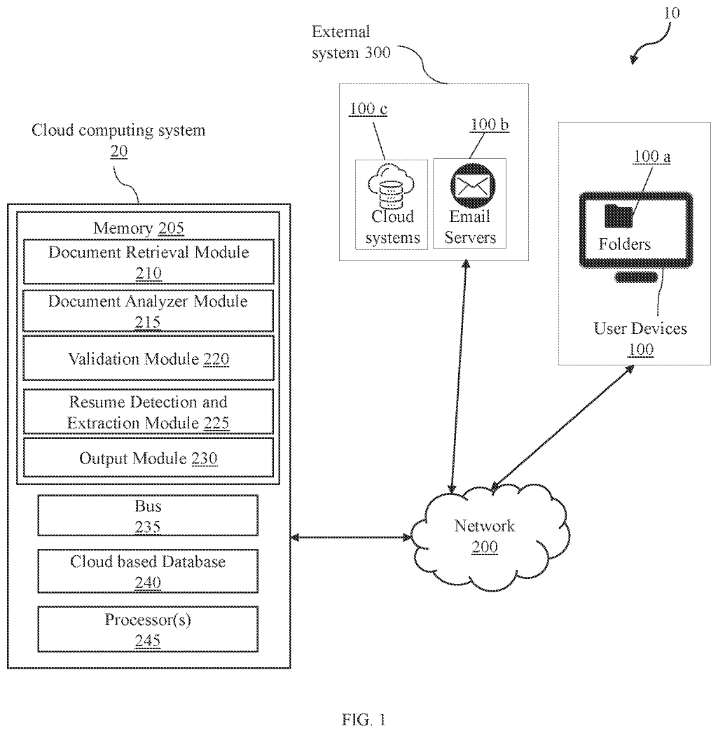

Referring now to the drawings, and more particularly to FIG. 1 through 3, where similar reference characters denote corresponding features consistently throughout the figures, there are shown preferred embodiments and these embodiments are described in the context of the following exemplary system and/or method.

FIG. 1 is a block diagram illustrating an exemplary cloud computing environment 10 for management of computing system 20 for automatic resume identification in accordance with an embodiment of the present disclosure. The computing system 20 is connected to one or more user devices 100 via a network 200 (e.g., Internet, Wi-Fi). The user devices 100 can be a laptop computer, desktop computer, tablet computer, smartphone and the like. The devices 100 can access computing system 20 via a web browser. Further, the devices 100 comprise plurality of documents saved in one or more folders 100a of the devices 100. Also, plurality of documents may be at one or more email servers 100b and at one or more cloud databases 100c. The plurality of documents may be in any format comprising a textual content. The computing system 20 may be a cloud computing system. The computing system 20 is further connected to external systems 300 via the network 200. The external system comprises email servers 100b and one or more external cloud databases 100c.

According to FIG. 1, the computing system 20 comprises one or more hardware processors 245, a bus 235, a cloud-based database 240 and a memory 205 coupled to the one or more hardware processors 245. The processor 245, and the memory 205, may be communicatively coupled by the bus 235 such as a system bus or a similar mechanism.

The cloud-based database 240 stores the information relating to the computing system 20 and data retrieved by the computing system 20. The cloud-based database 240 is, for example, a structured query language (SQL) data store. The cloud-based database 240 is configured as cloud-based database implemented in a cloud computing environment, where computing assets are delivered as a service over a cloud platform.

The processor(s) 245, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The processor(s) 245 may also include embedded controllers, such as generic or programmable logic devices or arrays, application specific integrated circuits, single-chip computers, and the like.

The memory 205 may be non-transitory volatile memory and non-volatile memory. The memory 205 may be coupled for communication with the processor(s) 245, such as being a computer-readable storage medium. The processor(s) 245 may execute machine-readable instructions and/or source code stored in the memory 205. A variety of machine-readable instructions may be stored in and accessed from the memory 205. The memory 205 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 205 includes a plurality of subsystems stored in the form of machine-readable instructions on any of the above-mentioned storage media and may be in communication with and executed by the processor(s) 245.

The memory 205 comprises a plurality of modules in the form of programmable instructions executable by the one or more hardware processors 245. The plurality of modules can be a document retrieval module 210, a document analyser module 215, a validation module 220, a resume detection and extraction module 225 and an output module 230. The document retrieval module 210 is configured to automatically retrieve one or more documents from one or more folders 100a on one or more user devices 100 and from one or more email servers 100b and one or more cloud databases 100c. The one or more user email servers 100b may include client-based email servers and web-based email servers. Further, the one or more cloud databases 100c may include public as well as private databases, such as drop box, google drive, and a like.

The document analyser module 215 is configured to analyse each of the one or more documents retrieved. Each of the one or more documents is analysed based on a set of analyser rules. The validation module 220 is configured to validate each of the analysed one or more documents by determining a score of resume-ness and a score of non-resume-ness of the each of the one or more documents. The score of resume-ness and the score of non-resume-ness of each of the one or more documents is determined based on one or more predefined rules. The resume detection and extraction module 225 configured to detect one or more resume based on the score of resume-ness and based on the score of non-resume-ness for each of the one or more documents. The output module 230 is configured to display the one or more resume detected on one or more user interfaces of the one or more user devices 100. The resume detection and extraction module 225 is further configured to extract one or more resumes from the pool of documents.

Those of ordinary skilled in the art will appreciate that the hardware depicted in FIG. 1 may vary for particular implementations. For example, other peripheral devices such as an optical disk drive and the like, Local Area Network (LAN), Wide Area Network (WAN), Wireless (e.g., Wi-Fi) adapter, graphics adapter, disk controller, input/output (I/O) adapter also may be used in addition or in place of the hardware depicted. The depicted example is provided for the purpose of explanation only and is not meant to imply architectural limitations with respect to the present disclosure.

Those skilled in the art will recognize that, for simplicity and clarity, the full structure and operation of all data processing systems suitable for use with the present disclosure is not being depicted or described herein. Instead, only so much of a computing system 20 as is unique to the present disclosure or necessary for an understanding of the present disclosure is depicted and described. The remainder of the construction and operation of the computing system 20 may conform to any of the various current implementation and practices known in the art.

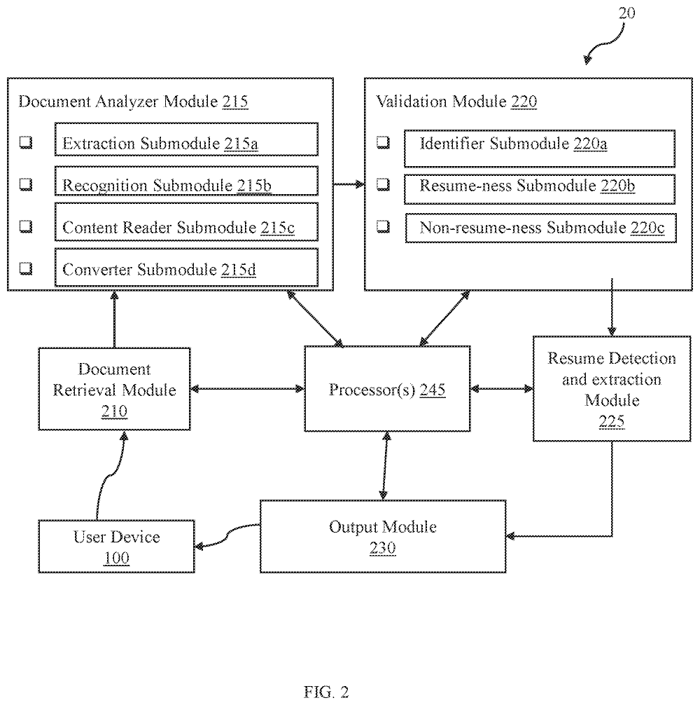

FIG. 2 is a block diagram illustrating an exemplary computing system 20, such as those shown in FIG. 1, for automatic resume identification from a bulk of documents, in accordance with an embodiment of the present disclosure. In FIG. 2, the computing system 20 depicts the document retrieval module 210, the document analyser module 215, the validation module 220, the resume detection and extraction module 225 and the output module 230 communicatively coupled with one or more user device 100 for automatically identify resume from a bulk of resumes. Further, the processor 245 is similar to that shown in FIG. 1. Hence, the description of such processor 245 is same as described above in FIG. 1.

The document retrieval module 210 is configured to automatically retrieve one or more documents from one or more folders 100a on one or more user devices 100 and from one or more email servers 100b and one or more cloud databases 100c. The document analyser module 215 is configured to analyse each of the one or more documents retrieved. Each of the one or more documents is analysed based on a set of analyser rules. The set of analyser rules comprises checking size of the documents in bytes, checking name of the documents (for example, does the name contain terms such as Resume/CV, and the like), format of the document (pdf, doc, jpeg, xls, and the like), number of characters or words in the document, the number of resume section headings found (for example, work experience, objective, qualifications, key skills, certifications, professional summary, goals, education, and the like), heading within the document, checking if the documents have work dates been mentioned, checking if the document has current job title been mentioned, if the document has college name been mentioned, if the document has some sort of degree or qualification been mentioned, are job description terms present which are typical of job ads on job boards, such as job description, required, preferred, should have, “we are looking for”, “ideal candidate will be”, and the like. These are required because a resume and a job description are actually very similar. These needs to distinguish. Further, the set of analyser rule may include type of the email mentioned in the file if any. For example, abc@gmail.com is a personal email and xyz@company.cloud is a business email. The resumes usually contain personal email ids. Further, the set of analyser rules comprises how many typical resume terms are present. For example, accomplished, designed, achieved, completed, created, led, performed, and the like. Also, the set of analyser rules may comprise how many miscellaneous document terms are present. Basically, the terms one would mostly not find on a resume. Example: Document heading as REPORT or ORDER or INVOICE or AGREEMENT or REVIEW, or text containing terms such as how to or instructions or congrats or greetings or please contact us and the like.

The validation module 220 is configured to validate each of the analysed one or more documents by determining a score of resume-ness and a score of non-resume-ness of the each of the one or more documents. The score of resume-ness and the score of non-resume-ness of each of the one or more documents is determined based on one or more predefined rules.

The resume detection and extraction module 225 is configured to detect one or more resume based on the score of resume-ness and based on the score of non-resume-ness for each of the one or more documents. An output module 230 is configured to display the one or more resume detected on one or more user interfaces of the one or more user devices 100.

The document analyser module 215 comprises an extraction submodule 215, a recognition submodule 215b, and a content reader submodule 215c. The extraction submodule 215 extracts one or more document properties based on the set of analyser rules. The one or more document properties comprise date of document creation, date of document modification, and author of document. The recognition submodule 215b recognizes document type, sender and recipient of the document based on the set of analyser rules.

The content reader submodule 215c reads information contained in the document based on the set of analyser rules. The content reader submodule 215c further comprises an OCR component configured to read the one or more documents, using an image reader technique. As shown in FIG. 2, in an exemplary embodiment of present invention, the document analyser 215 further comprises a converter submodule 215d configured to convert the one or more document in a standard compatible format for reading if the recognition submodule 215b recognizes the document type of the one or more document in an incompatible format. The standard compatible formats may be in the form of document types which includes textual content, for example, ‘.doc’, ‘.docx’, ‘.pdf’, ‘.odt’, and the like. The incompatible formats may be document types without text.

The validation module 220 comprises an identifier submodule 220a which identifies one or more resume attributes, and one or more non-resume attributes, in each of the one or more documents through a pattern recognition technique. Further, the validation module 220 comprises a resume-ness submodule 220b and a non-resume-ness submodule 220c.

The resume-ness submodule 220b determines the score of resume-ness of each of the one or more documents based on one or more predefined resume attributes identified. The one or more predefined rules to determine the score of resume-ness comprises detecting one or more predefined resume attributes in the document, the one or more predefined resume attribute comprises one or more resume sections, one or more typical resume phrase, one or more experience details, one or more education details, one or more email id type, syntax of filename of the document.

The resume-ness submodule 220b assigns a resume-ness value for detection of each of the one or more predefined resume attributes in a document. Further, the resume-ness submodule 220b accumulates the resume-ness value to determine the score of resume-ness.

If the score of resume-ness is within a predefined resume-ness threshold, the resume detection and extraction module 225 detects the document is a resume. The resume detection and extraction module 225 also extracts one or more resumes from the pool of documents.

The non-resume-ness submodule 220c determines the score of non-resume-ness of each of one or more documents based on the one or more keywords and one or more format of writing identified. The one or more predefined rules to determine the score of non-resume-ness comprises detecting one or more predefined non-resume attributes in the document.

The one or more predefined non-resume attribute comprises one or more non-resume type format, one or more typical non-resume phrase, and one or more non-resume details.

Non-resume type format may include letter type format, agreement type format, proposal type format, event scheduling format, and the like. Typical non-resume phrase may include second person pronouns, third person pronouns, promotional phrases, and the like. The non-resume-ness submodule 220c assigns a non-resume-ness value for detection of each of the one or more predefined non-resume attributes. Further, the non-resume-ness submodule 220c accumulates the non-resume-ness value to determine the score of non-resume-ness. If the score of non-resume-ness is within a predefined non-resume-ness threshold, the resume detection and extraction module 225 detects the document is not a resume. Further, the resume detection and extraction module 225 stores the one or more resumes detected in a library of resumes in the cloud-based database 240. In an embodiment, the resume detection and extraction module 225 is further configured for creating a resume library for the one or more resumes detected and storing the one or more resumes detected in the resume library of the cloud-based database 240.

In an exemplary embodiment, let us take a non-resume-ness example first. That is those documents that are not resumes are to be eliminated first. If the document contains more than 50,000 characters, then it is determined as not a resume as it is way too long to be a resume. On the other hand, if the document contains a lot of “You/Yours in the document (typical of a letter addressed to a person reading it, and at the same time very unlike a resume since a resume is all about oneself), and the number of typical resume terms mentioned is close to zero and the document name is also not even possibly being a resume file name (or example if it is named as invoice or order or report or agreement and the like), then it is determined not a resume.

Further, if the document contains way too many financial figures, and it has too less resume terms, and the name of the document is very unlike a resume name, again mark it as a non-resume. Further, if there are a lot of numbers in the document such as 150 or more, and it has very few resume terms, non-resume file name, again the document is marked as a non-resume.

Furthermore, if the document has a lot of times mentioned like 6 am-10 am, 12 pm to 3 pm, and has very few resume terms, and a non-resume file name, then the document is most likely some memo or schedule or similar to that. Similarly, for legal documents, it is checked if words such as agreement, trademark, all rights reserved, and so are present, very few resume terms are present, and document name is unlike that of a resume, then the document is marked as non-resume.

In case of resume-ness, if the heading of the document itself is resume or CV or curriculum vitae, and the like, and it has a typical resume document name such as name_resume.docx, then the document is marked as a resume. Further, if the document has a lot of typical resume terms, example, sentences starting with “Designed”, “Created”, “Developed”, and the like, and it has a possible resume file name, and no miscellaneous document terms, then the document is marked as a resume.

An example of a more complex rule is by determining whether a work experience section has been found of the document. The work experience may be called professional experience, work summary, career profile and the like. Later, it is checked whether typical resume terms are present. If yes, then the document is marked as a resume. Another rule is to check whether an education section has been found in the document. The education section can also be referred in different ways. If yes, and the document contains typical resume terms, then the document is marked as a resume. The education and work sections are two sections that are found on mostly every resume. And hence, if these sections are present, and if there are typical resume terms, then the document is marked as resume.

Another even more complex rule is that if the document contains a personal email id, a job title phrase such as marketing manager, software engineer, and the like and has typical resume terms, then the document is marked as a resume. If the document contains the name of a person at the top, has work experience dates mentioned (example, January 2007-present) and has typical resume terms or typical resume sections, then the document is marked as a resume.

Furthermore, if the score of resume-ness is beyond a predefined resume-ness threshold and/or if the score of non-resume-ness is beyond a predefined non-resume-ness threshold, the resume detection and extraction module 225 detects one or more resume documents based on a heuristic process. The resume detection and extraction module 225 stores an updated version of resume in the library replacing a previous version. The resume detection and extraction module 225 also prevents duplication of a prestored resume in the library.

In an embodiment, the resume detection and extraction module 225 is configured to validate the one or more detected resume based on one or more predefined criteria. The one or more predefined criteria comprises document version and user profile information.

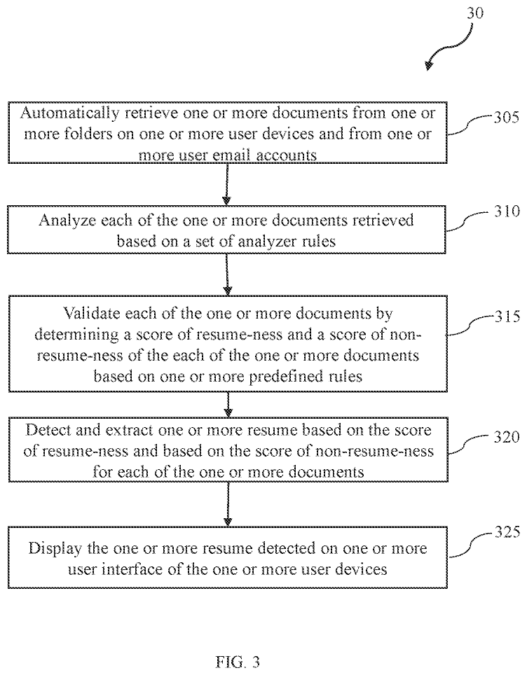

FIG. 3 is a process flow diagram illustrating exemplary method 30 for automatic resume identification, in accordance with an embodiment of the present disclosure. At step 305, one or more documents are received from one or more folders 100a on one or more user devices 100, from one or more email servers 100b and from one or more cloud databases 100c. At step 310, each of the one or more documents retrieved are analysed. Each of the one or more documents is analysed based on a set of analyser rules. At step 315, each of the one or more documents is validated by determining a score of resume-ness and a score of non-resume-ness of the each of the one or more documents based on one or more predefined rules. At step 320, one or more resume is detected and/or extracted based on the score of resume-ness and based on the score of non-resume-ness for each of the one or more documents. At step 325 the one or more resume detected are displayed on one or more user interface of the one or more user devices 100.

Further, the method 30 comprises, during analysing each of the one or more documents, one or more document properties extracted by an extraction submodule 215 based on the set of analyser rules. The one or more document properties comprise, date of document creation, date of document modification, and author of document. Document type, sender and recipient of the document are recognized by a recognition submodule 215b based on the set of analyser rules. Also, information contained in the document is read by a content reader submodule 215c based on the set of analyser rules. The reading one or more documents comprises reading the one or more documents using an image reading technique.

Further, the method 30 comprises during analysing each of the one or more documents, the one or more documents are converted in a standard compatible format for reading if the recognition submodule 215b recognizes the document type of one or more document in an incompatible format. The standard compatible formats may be in the form of document types which includes textual content such as for example, ‘.doc’, ‘.docx’, ‘.pdf’, ‘.odt’, and the like. The incompatible formats may be document types without textual content.

Further, the method 30 comprises during validating one or more documents one or more resume attributes, and one or more non-resume attributes are identified in each of the one or more documents through a pattern recognition technique. The score of resume-ness of each of the one or more documents is determined based on the one or more resume attributes identified. The one or more predefined rules to determine the score of resume-ness comprises detecting one or more predefined resume attributes in the document. The one or more predefined resume attribute comprises one or more resume sections, one or more typical resume phrase, one or more experience details, one or more education details, one or more email id type, and syntax of filename of the document.

Example of resume sections may be work experience, education, and the like. Example of typical resume phrase may be achieved, improved, managed, resolved, and the like. Experience details may include job title, years of experience, and the like. Education details may include degree, passing year, and the like. Email id type may be personal email ids, business email ids, job board email ids, and the like. Syntax of filename of the document may include candidate's name, resume specific keywords, such as—job title, word resume, and the like. A resume-ness value is assigned for detection of each of the one or more predefined resume attributes. Further, the resume-ness value is determined by accumulating the score of resume-ness. The document is detected as a resume if the score of resume-ness is within a predefined resume-ness threshold.

The score of non-resume-ness of each of the one or more documents is determined based on the one or more non-resume attributes identified, the one or more predefined rules to determine the score of non-resume-ness comprises detecting one or more predefined non-resume attributes in the document. The one or more predefined non-resume attribute comprises one or more non-resume type format, one or more typical non-resume phrase, and one or more non-resume details.

Non-resume type format may include letter type format, agreement type format, proposal type format, event scheduling format, and the like. Typical non-resume phrase may include second person pronouns, third person pronouns, promotional phrases, and the like. A non-resume-ness value is assigned for detection of each of the one or more predefined non-resume attributes. Further, the non-resume-ness value is determined by accumulating the score of non-resume-ness. The document is detected as non-resume if the score of non-resume-ness is within a predefined non-resume-ness threshold. Further, the one or more resumes detected in a library of resumes is stored in the cloud-based database 240.

Further, the method 30 comprises detecting the one or more resume documents based on a heuristic process if the score of resume-ness is beyond a predefined resume-ness threshold and/or if the score of non-resume-ness is beyond a predefined non-resume-ness threshold. The heuristic process has been arrived by observance and classification of hundreds of thousands of files spread over emails and desktops.

Various embodiments of the present system provide a technical solution for the problem of difficulty in identifying resume from bulk of documents in different folders of user devices and in different email servers and in different cloud databases. The computing system 20 and method 30 facilitates automatic resume identification in a cloud computing environment, by instantly detecting that whether a document in a bulk of documents, is a resume or not, regardless of the way in which the resume has been written, with 99.5%+accuracy with false positive rate of 0.5% and false negative rate of 0.5%. The present system not only identifies resumes but also creates a unique library of resumes of relevant candidates. Further, it periodically keeps synchronizing the library based on the available documents. The present system provides an intelligent resume extractor capable of extracting resumes only out of a pool of documents.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown, nor do all of the acts need to be necessarily performed. Also, those acts that are not dependent on other acts may be performed in parallel with the other acts. The scope of embodiments is by no means limited by these specific examples.

We claim:

1. A computing system for automatic resume identification in a cloud computing environment, the system comprising:
one or more hardware processors; and
a memory coupled to the one or more hardware processors, wherein the memory comprises a plurality of modules in the form of programmable instructions executable by the one or more hardware processors, wherein the plurality of modules comprises:
a document retrieval module configured to automatically retrieve one or more documents from one or more folders on one or more user devices, one or more email servers and from one or more cloud databases;
a document analyzer module configured to analyze each of the one or more documents retrieved wherein each of the one or more documents is analyzed based on a set of analyzer rules,
a validation module configured to validate each of the analysed one or more documents by determining a score of resume-ness and a score of non-resume-ness of the each of the one or more documents, wherein the score of resume-ness and the score of non-resume-ness of each of the one or more documents is determined based on one or more predefined rules:
a resume detection and extraction module configured to detect one or more resume based on the score of resume-ness and based on the score of non-resume-ness for each of the one or more documents, and
an output module configured to display the one or more resume detected on one or more user interfaces of the one or more user devices.

2. The system as claimed in claim 1, wherein the resume detection and extraction module is further configured for:
creating a resume library for the one or more resumes detected; and
storing the one or more resumes detected in the resume library of the cloud-based database.

3. The system as claimed in claim 1, wherein in analyzing each of the one or more documents, the document analyzer module comprises:
an extraction submodule to extract one or more document properties based on the set of analyzer rules, wherein the one or more document properties comprise: date of document creation, date of document modification, and author of document;
a recognition submodule to recognize document type, sender and recipient of the document based on the set of analyzer rules; and
a content reader submodule to read information contained in the document based on the set of analyzer rules.

4. The system as claimed in claim 1, wherein in analyzing each of the one or more documents, the document analyzer module comprises a converter submodule configured to convert the one or more document in a standard compatible format for reading if the recognition submodule recognizes the document type of the one or more document in an incompatible format.

5. The system as claimed in claim 1, wherein in validating one or more documents retrieved, the validation module comprises:
an identifier submodule to identify one or more resume attributes, and one or more non-resume attributes in each of the one or more documents through a pattern recognition technique:
a resume-ness submodule to determine the score of resume-ness of each of the one or more documents based on one or more predefined resume attributes identified; and
a non-resume-ness submodule to determine the score of non-resume-ness of each of the one or more documents based on one or predefined resume attributes identified.

6. The system as claimed in claim 1, wherein in detecting one or more resume, the one or more predefined rules to determine the score of resume-ness, the resume detection and extraction module configured to:
detecting one or more predefined resume attributes in the document, the one or more predefined resume attribute comprises one or more resume sections, one or more typical resume phrase, one or more experience details, one or more education details, one or more email id type, syntax of filename of the document;
assigning a resume-ness value for detection of each of the one or more predefined resume attributes; and
accumulating the resume-ness value to determine the score of resume-ness.

7. The system as claimed in claim 1, wherein in detecting the one or more resume, the one or more predefined rules to determine the score of resume-ness, the resume detection and extraction module configured to:
validating the one or more detected resume based on one or more predefined criteria,
wherein one or more predefined criteria comprises document version and user profile information.

8. The system as claimed in claim 1, wherein in detecting the one or more resume, the one or more predefined rules to determine the score of non-resume-ness, the resume detection and extraction module configured to:
detecting one or more predefined non-resume attributes in the document, the one or more predefined non-resume attribute comprises one or more non-resume type format, one or more typical non-resume phrase, and one or more non-resume details:
assigning a non-resume-ness value for detection of each of the one or more predefined non-resume attributes; and
accumulating the non-resume-ness value to determine the score of non-resume-ness.

9. The system as claimed in claim 1, wherein in detecting one or more resume, if the score of resume-ness is within a predefined resume-ness threshold, the resume detection and extraction module detects the document is a resume.

10. The system as claimed in claim 1, wherein in detecting one or more resume, if the score of non-resume-ness is within a predefined non-resume-ness threshold, the resume detection and extraction module detects the document is not a resume.

11. The system as claimed in claim 1, wherein in detecting one or more resume, if the score of resume-ness is beyond a predefined resume-ness threshold and/or if the score of non-resume-ness is beyond a predefined non-resume-ness threshold, the resume detection and extraction module detects one or more resume documents based on a heuristic process.

12. A computer implemented method for automatic resume identification in a cloud computing environment, the method comprising:
retrieving automatically, by a document retrieval module executable by the one or more hardware processors, one or more documents from one or more folders on one or more user devices, and from one or more email servers and from one or more cloud databases;
analyzing, by a document analyzer module, each of the one or more documents retrieved wherein each of the one or more documents is analyzed based on a set of analyzer rules; and
validating, by a validation module executable by the one or more hardware processors, each of the one or more documents by determining a score of resume-ness and a score of non-resume-ness of the each of the one or more documents based on one or more predefined rules; and
detecting, by a resume detection and extraction module executable by the one or more hardware processors, one or more resume based on the score of resume-ness and based on the score of non-resume-ness for each of the one or more documents, and
displaying, by an output module executable by the one or more hardware processors, the one or more resume detected, on one or more user interface of the one or more user devices.

13. The method as claimed in claim 12, wherein the method further comprises:
creating a resume library for the one or more resumes detected; and
storing the one or more resumes detected in the resume library of the cloud-based database.

14. The method as claimed in claim 12, wherein analyzing each of the one or more documents comprises:
an extraction submodule to extract one or more document properties based on the set of analyzer rules, wherein the one or more document properties comprise: date of document creation, date of document modification, and author of document;
a recognition submodule to recognize document type, sender and recipient of the document based on the set of analyzer rules; and
a content reader submodule to read information contained in the document based on the set of analyzer rules.

15. The method as claimed in claim 12, wherein analyzing each of the one or more documents comprises converting the one or more document in a standard compatible format for reading if the recognition submodule recognizes the document type of one or more document in an incompatible format.

16. The method as claimed in claim 12, wherein validating one or more documents retrieved comprises:
identifying one or more resume attributes, and one or more non-resume attributes in each of the one or more documents through a pattern recognition technique;
determining the score of resume-ness of each of the one or more documents based on the one or more keywords and one or more format of writing identified; and
determining the score of non-resume-ness of each of the one or more documents based on the one or more keywords and one or more format of writing identified.

17. The method as claimed in claim 12, wherein the one or more predefined rules to determine the score of resume-ness comprises:
detecting one or more predefined resume attributes in the document, the one or more predefined resume attribute comprises one or more resume sections, one or more typical resume phrase, one or more experience details, one or more education details, one or more email id type, and syntax of filename of the document;
assigning a resume-ness value for detection of each of the one or more predefined resume attributes; and
accumulating the resume-ness value to determine the score of resume-ness.

18. The method as claimed in claim 12, wherein in detecting the one or more resume, the one or more predefined rules to determine the score of resume-ness comprises:
validating the one or more detected resume based on one or more predefined criteria,
wherein one or more predefined criteria comprises document version and user profile information.

19. The method as claimed in claim 12, wherein the one or more predefined rules to determine the score of non-resume-ness comprises:
detecting one or more predefined non-resume attributes in the document, the one or more predefined non-resume attribute comprises one or more non-resume type format, one or more typical non-resume phrase, one or more non-resume details;
assigning a non-resume-ness value for detection of each of the one or more predefined non-resume attributes; and
accumulating the non-resume-ness value to determine the score of non-resume-ness.

20. The method as claimed in claim 12, wherein detecting one or more resume based on the score of resume-ness and based on the score of non-resume-ness for each of the one or more documents comprises:
detecting the document as a resume if the score of resume-ness is within a predefined resume-ness threshold.

21. The method as claimed in claim 12, wherein detecting one or more resume based on the score of resume-ness and based on the score of non-resume-ness for each of the one or more documents comprises:
detecting the document as non-resume if the score of non-resume-ness is within a predefined non-resume-ness threshold.

22. The method as claimed in claim 12, wherein detecting the one or more resume based on the score of resume-ness and based on the score of non-resume-ness for each of the one or more documents comprises:
detecting the one or more resume documents based on a heuristic process if the score of resume-ness is beyond a predefined resume-ness threshold and/or if the score of non-resume-ness is beyond a predefined non-resume-ness threshold.
